(19) United States
(12) Patent Application Publication
(10) Pub. No.: US 2017/0226010 A1
(43) Pub. Date: Aug. 10, 2017

(54) Lithium Infused Processed Fly Ash for the Production of High Strength Cementitious Products

(71) Applicant: VHSC, Ltd., Tortola (VG)

(72) Inventor: Clinton Wesley Pike, SR., Montgomery, TX (US)

(21) Appl. No.: 15/019,427

(22) Filed: Feb. 9, 2016

(51) Int. Cl. C04B 22/00

(52) U.S. Cl. CPC C04B 22/0093

(57) ABSTRACT

A process is provided for treating raw fly ash used in cementitious material so as to increase the strength of the cementitious material while at the same time providing a near linear strength increase for the material as it cures by processing the raw fly ash, as by milling, and by mixing the processed fly ash with a catalyst such as lithium, with the lithium concentration in the fly ash being between 0.05% and 0.25% by weight. The process applies to Class C fly ash and Class F fly ash when mixed with Class C fly ash. All of the above processes include the use of polycarboxylates.

### FIELD OF INVENTION

This invention relates to processed fly ash and more particularly to the infusion of lithium in processed fly ash to increase strength and to make sure that the strength increases are linear over time.

### BACKGROUND OF THE INVENTION

As described in a co-pending patent application Ser. No. 14/966,707 entitled Lithium Infused Raw Fly ash for the Production of High Strength Cementitious Products, filed Dec. 11, 2015, it has been found that treating raw Class C fly ash with lithium markedly increases the strength of the cement produced from the raw fly ash. What has however been found is that while the 3 day and 28 day strengths of the raw fly ash have repeatable superior compressive strengths, in the time period between the third day and the 28^{th} day the strength of the cement does not increase as much but rather is flat, i.e. it plateaus. The result is that after the third day there are no consistent strength increases for up to 14 days. Note the above strength measurements are made under ASTM C 989 where the pozzolan or fly ash is mixed 50-50 by weight with type 1-2 Original Portland. Cement and tested as a slag.

In summary, in the 14 days following the third day, the strength does not exhibit constantly increasing strength gain but rather the strength gain curve seems to flatten out. In short, the strength gain seems to hold at a strength gain which does not indicate a daily or weekly increase or not much of an increase at all. For instance, while in one embodiment a day 7 compressive strength was found to be 5577 psi, this compressive strength stayed flat and did not increase much until after the 21^{st} day. Thereafter, at or about the 21^{st} day to the 28^{th} day, the strength jumped to 7590 psi.

While having a somewhat flat strengthening rate from day 7 to about day 21 is suitable in a great many cement and concrete applications where one can wait seven days for one strength or one can wait for 28 days for another strength, if one has jobs which must be completed for instance between the 7^{th} and the 28^{th} day, having a strength gain hiatus is unacceptable.

By way of example, if a 7 day strength that meets the required strength of a particular job, for instance equivalent to 5577 PSI as expressed in concrete, it could be deemed to be acceptable and one can complete the job and move off to another job. However if one needs for instance a particular 14 day strength, assuming the use of raw fly ash, there will be little strength increase after the 7th day to day 14 due to the non-linear strength increase when using raw unprocessed fly ash.

Thus, while 7 day and 28 day compressive strengths utilizing raw fly ash and lithium are impressive, the plateau in strengthening between the 7^{th} day and 28^{th} day can prevent the use of raw lithium treated fly ash in some situations.

It would therefore be desirable to provide fly ash whose strength increases are continuous with no hiatus. Put another way, one needs a cement with a continuous strength increase over time so that one can plan to leave the job site when a specified cement compressive strength is calculated to have been reached.

### SUMMARY OF THE INVENTION

It has now been found that as opposed to utilizing raw fly ash, processing fly ash through grinding and adding a catalyst such as lithium to the processed fly ash results in continuous strength increases over time without plateauing. Processing as used herein refers to grinding or milling of the raw fly ash prior to the introduction of the lithium and, in one embodiment, utilizes a specialized mill to increase the surface area of raw fly ash. In a preferred embodiment, the above milling or grinding results in at least a 10% surface area increase to the milled fly ash.

As a result of the raw fly ash processing, strength increases linearly over time. This predictability permits planning job site schedules to match a required cement strength.

The relative linearity of the strength increases over time when utilizing processed fly ash as opposed to raw fly ash is shown in the following table in which the numbers represent the psi at which a cube sample is crushed:

TABLE I
C989 testing
50/50 Cement/Fly ash Mixture

| | 1 d | 3 d | 7 d | 14 d | 28 d |
|---|---|---|---|---|---|
| Li treated raw ash | 2680 | 5125 | 5577 | 5920 | 7590 |
| Li treated w mill | 2847 | 4395 | 5902 | 6712 | 7847 |

Here it can be seen that from day 3 to day 28 for raw fly ash there is relatively little strength increase until one gets to day 28. Thus, the increase from 5125 to 5577 and then to 5920 from day 3 to day 14 is not significant and represents a plateau in strength gain or increase.

However, for the milled or processed fly ash, the strength at day 3 to day 14 increases by about 1000 psi on a regular basis. Thus, with processed fly ash the strength gains are relatively linear and predictable.

More particularly, this invention relates to processed Class C fly ash or processed Class C fly ash and Class F fly ash that has at least 25% of an ASTM Class C fly ash added to it. These products when used correctly make high strength cementitious products having strength that increases over time without flattening or hiatus in strength gain. In short, when using processed fly ash and lithium, one has a continuous strength increase without any slowdown in early strength.

Specifically, it has now been found that the addition of lithium compounds to processed fly ash at 0.05% by weight or greater of the fly ash, alone or with the addition of sulfite, provides a cement that continuously gains strength well past the normal strength gains seen with Ordinary Portland Cement. Not only is the strength gain continuous, it has also been found that the resulting cement exhibits 1.5-2 times higher strength when compared to the strength associated with untreated fly ash added to Ordinary Portland Cement.

In one embodiment, it is possible to obtain nearly 1.5 times the strength associated with Ordinary Portland Cement, OPC, when utilizing processed fly ash and a lithium compound or a lithium/sulfite combination of the type described herein. The above strength increase assumes the use of polycarboxylate at 0.175% by weight of the fly ash or pozzolan in the ASTM 0989 protocol.

While the subject invention will be described in terms of the use of lithium, it has been found that other catalysts such as beryllium are effective in activating the Class C fly ash.

It is thought that the grinding and chemical activation involving the lithium catalyst is uniquely applicable to aluminum-based compounds, especially those found in Class C fly ash. As a result, the methods described herein are directed primarily to the aluminum-based compounds found in Class C fly ash, with the aluminum-based compounds producing high early strength cementitious products. This is because of the chemistry of the lithium compounds that activate Class C fly ash.

Moreover, by blending the Class C fly ash with a Class F fly ash at 25% or more by weight replacement, one gains considerable strength over a processed Class F fly ash without the Class C fly ash when a lithium compound at 0.05% or greater is added.

As to the specialized mill utilized in the subject invention that is responsible in one embodiment for processing the fly ash, as described in U.S. patent application Ser. No. 13/647,838 entitled Process for Treating Fly Ash with a Rotary mill by Clinton W. Pike filed Oct. 9, 2012 and incorporated herein by reference, fly ash can be ground down using a specialized rotary mill having a multimedia charge to increase the surface area of the fly ash. It is noted that this mill can increase the surface area by as little as 10% and still be effective, especially when using polycarboxylate additives.

It is noted that lithium has in fact been utilized in such a mill. As described in U.S. Pat. No. 8,967,506, such a milling technique can utilize additives to obtain slag grade 120 concrete. One of these additives is the addition of 2% by weight of calcium aluminate cement to which is added lithium at 0.1% of the calcium aluminate cement. The net result is a concentration of 0.00002% of lithium in the inter-ground mixture. Note, this minimal amount of lithium is essentially just enough to activate the compounds in the calcium aluminate cement.

Thus, while lithium has been ground with fly ash in the above specialized mill, its use is only in minute amounts too small to materially affect the strength of Class C fly ash. In short, the utilization of lithium in the minute amounts specified in the aforementioned patent application is ineffective to provide noticeable strength gain or affect the minerals in the Class C fly ash such as Merwinite that promote strength gain.

In summary, a process is provided for treating raw fly ash used in cementitious material so as to increase the strength of the cementitious material while at the same time providing a near linear strength increase for the material as it cures by processing the raw fly ash, as by milling, and by mixing the processed fly ash with a catalyst such as lithium, with the lithium concentration in the fly ash being between 0.05% and 0.25% by weight. The process applies to Class C fly ash and Class F fly ash when mixed with class C fly ash. All of the above processes include the use of polycarboxylates

### DETAILED DESCRIPTION

By way of further background, as to the availability of raw fly ash, in coal-fired power stations processes are employed to reduce the amount of S02 emissions from the combustion of coal. The key to the reduction of S02 emissions is the burning of coals that have less sulfur in them to start with. The preferred coal that meets this requirement is found in the Powder River Basin in Wyoming. This coal is a subbituminous coal and has a much lower sulfur content in it than older coals such as bituminous coals. The burning of low sulfur subbituminous coal in coal fired power plants produces what is defined by ASTM C 618 as Class C fly ash. Removal and disposal of this fly ash from coal-fired plants has been costly, and efforts have been devoted to find uses for the raw fly ash which are commercially viable to offset disposal and or removal costs.

While a large portion of raw fly ash is buried in on site landfills or carted off to landfills, the raw fly ash has been used as flowable fill product or backfill material because of its ability to set up for instance within 30 minutes. This quick setting characteristic of this type of fly ash is however offset by the relatively low strength of the cement produced in this manner. For instance, in a seven day test of raw fly ash, the compressive strength is only for instance 2925 psi. On the other hand, utilizing processed fly ash and treating it with lithium results in compressive strength of over 5000 psi. It was found that the strength of processed fly ash exceeded 5000 psi. in seven days when lithium compounds were added at greater than 0.05% of the fly ash and with a 0.175% by weight of polycarboxylate. This in turn makes the fly ash usable in a number of applications and makes removal of the fly ash profitable.

It will be noted that cementitious products having compressive strength of greater than 5000 psi in general exceed grade 120 slag performance and are useful in a wide variety of high strength cement applications. In fact, cements having a grade 100 slag determination or better have proven to be satisfactory in many applications to reduce the amount of Old Portland Cement used and to lessen the amount of total cementitious material used to make a cubic yard of suitably strong concrete that meets or exceeds design strength.

It has now been found that by adding as little as 0.05% of lithium chloride to processed Class C fly ash one can achieve a seven day compressive strength of 5225 psi and a 28 day compressive strength of 7850 psi., with the compressive strength continuously increasing without a levelling off of compressive strength between the seventh and 14^{th} day. Note that the 0.05% relates to the minimum amount of lithium compound per unit weight of fly ash. When fly ash is mixed 50-50 with Old Portland Cement, the minimum concentration of lithium is 0.025% by weight of the total mixture. While the minimum amount of lithium described is 0.5%, a more useful range is 0.1%-0.25%.

Moreover, it has been found that one can take processed Class F fly ash and add calcium containing minerals to it to approximate Class C fly ash. In one embodiment, Class F fly ash can be mixed with 17.5-20% of fly ash containing CaO-containing minerals to produce a blended raw Class F fly ash that can be processed and activated with lithium to provide a high strength cement. It additionally has been found that that a blend of 30% raw Class F fly ash with Class C fly ash containing greater than 28% by weight of CaO minerals is optimal when lithium activating the Class C fly ash minerals. The blended fly ash, when ground with lithium at 0.05% or greater of the total powder and a polycarboxylate at 0.175% of the fly ash, then gives a one day strength 10-20% higher than pure OPC and 40% higher than pure OPC in 28 days.

Further, one can intergrind raw Class C fly ash in the above-mentioned specialized multimedia mill with raw Class F fly ash to provide a processed fly ash with exceptional strength.

It will be noted that Class F fly ash is defined as having greater than 70% iron, silica and aluminum, with Class C fly ash being defined as having less than 70% of these constituents.

Note, lithium comes in a variety of forms including lithium hydroxide, lithium chloride and lithium carbonate. It has further been found that lithium in its various forms has proven to be effective in the range of 0.05%-0.25%. Moreover it has been found that milling Class C fly ash with Class F fly ash provides a blend when mixed with lithium that can be given superior strength characteristics and linear cure rates.

In one embodiment the lithium is introduced in the form of lithium chloride at rates of 0.05% or higher that reacts with Merwinite or calcium aluminate compounds normally found in Class C fly ash. It appears that Class C fly ash regularly has amounts of Merwinite on the order of 8-25%. When lithium reacts with the Merwinite in the fly ash, it has been found that the strength of the cementitious material increased by 20% or more after seven days.

Moreover, it has been found that lithium reacts with minerals in fly ash having a high calcium content. Not only does Merwinite have such a high calcium content, so does Monocalcium aluminate, Dodeca calcium hepta-aluminate and belite. Since these minerals can be found in Class C fly ash, lithium acts as a catalyst to strengthen these fly ashes, with the subject fly ash processing assuring continuous strengthening over time.

In short, it has been found that inter-grinding lithium chloride at greater than 0.5% with the processed fly ash and adding a polycarboxylate at just 0.0875% of the fly ash results in cementitious material having continuously increasing strength over time, with the cement exceeding 120 slag performance as measured by the ASTM C 989 test method with the fly ash used as a slag. Moreover, it has been found that when utilizing this processed lithium fly ash mixture to replace 60% of OPC, instead of the standard 50% replacement, a minimum grade 120 slag performance is achieved based on the same ASTM C 989 test.

As a byproduct of the use of lithium, its use also imparts significant ASR remediation to the cementitious product. Thus, there is a significant alkali silica reaction reduction benefit when using fly ash infused with lithium.

In summary, lithium is mixed with processed fly ash and a polycarboxylate to provide a high strength cementitious product with a significant and continuous strength improvement, while at the same time achieving significant ASR reduction.

Key to the imparting of strength to fly ash using the lithium activation and aiding ASR protection is keeping percent of the total CaO in the blended fly ash between 17.5 and 22% or lower. If the presence of CaO in the blended fly ash exceeds 26%, many in the industry will frown on the ASR potential in the blended fly ash. Ordinarily it is desirable to keep the total percentage of calcium below 26% to help eliminate ASR problems. However, with the addition of lithium and its proven ASR remediation, higher percentages of calcium do not become problematic.

As to Class F fly ash, Class F fly ash for instance from lignite is not high enough in calcium rich minerals to be activated by lithium for providing the requisite strength. Thus, Class F fly ash in general does not lithium activate because the amount of calcium rich mineral does not typically exceed 11%.

On the other hand, Powder River basin fuel, which is a relatively young coal and comes from Wyoming, produces a calcium rich mineral content of between 22 to 45% when burned. With lignite having no more than about 14% calcium rich mineral content when blended for instance with subbituminous coal which has a calcium rich mineral content considerably higher than other coals, then the blending of the Class F fly ash from for instance lignite, with subbituminous coal at a ratio of for instance 40% lignite coal by weight to 60% subbituminous coal by weight, the result is a blended fuel that when burned together produces a fly ash having a sufficient amount of calcium rich mineral to be activated to impart the aforementioned strength and still has the chemical properties of a Class F fly ash and is thus easily accepted in the industry to help stop ASR.

Thus, while the subject invention is described in terms of treating raw Class C fly ash with lithium chloride or other lithium compounds, it is possible to create a blended mixture of Class C and Class F fly ash either by blending and burning lignite and Powder River basin coal or blending the separate fly ashes to achieve the strengths associated with the activated Class C fly ash.

The amount of lithium compound, be it lithium hydroxide, lithium chloride or lithium carbonate is optimally on the order of 0.1% to 0.2%. More than 0.2% of a lithium additive can make the process more expensive such that the practical limit for the amount of lithium compound is less than 0.2% by weight of fly ash.

Note that fly ash need not come from coal-fired power plants. The fly ash in question can come from any source in which coal is milled down and burned at temperatures equal to or above 2500° F. Note that the smaller municipal or industrial boilers using coal as the fuel produces the same type of ashes.

While the present invention has been described in connection with the preferred embodiments, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended Claims.

What is claimed is:

1. A method for increasing the strength of cementitious materials utilizing fly ash and for providing a strength gain over time without hiatus for cementitious materials, comprising the steps of:
processing raw fly ash by milling the fly ash so as to increase the surface area thereof; and,
mixing the processed fly ash with lithium in an amount sufficient to activate the fly ash.

2. The method of claim 1, wherein the fly ash includes Class C fly ash.

3. The method of claim 2, wherein the fly ash includes Class F fly ash.

4. The method of claim 1, and further including mixing fly ash with a polycarboxylate.

5. The method of claim 2, wherein the Class C fly ash and the Class F fly ash are raw fly ashes that are subsequently processed prior to being mixed with lithium.

6. The method of claim 2, wherein only the Class C fly ash is processed.

7. The method of claim 2, wherein both the Class C and Class F fly ashes are processed prior to mixing with lithium.

8. The method of claim 1, wherein the concentration of lithium in fly ash is between 0.05% and 0.25% by weight.

9. The method of claim 1, wherein the processing of the raw fly ash is accomplished utilizing a rotary mill.

10. The method of claim 9, wherein the rotary mill has a multimedia charge.

11. The method of claim 1, wherein the milling results in fly ash having a surface area expanded by at least 10% due to the milling.

12. A cementitious material having been made from fly ash which has been processed and mixed with lithium ash with lithium in an amount sufficient to activate the fly ash.

13. A cementitious material having been made from processed fly ash activated with a catalyst that both increases the strength of the cement over that associated with unprocessed fly ash and which exhibits continuous strength increases over time without plateauing.

14. The cementitious material of claim 13, wherein the catalyst includes one of lithium or beryllium.

15. A method of imparting a continuous strengthening characteristic to raw fly ash used to produce a cementitious material that avoids strength gain plateauing by processing the fly ash and adding lithium to the processed fly ash.

16. The method of claim 15, wherein the concentration of lithium in the processed fly ash is between 0.05% and 0.25%.

17. The method of claim 16, wherein the fly ash includes Class C fly ash.

18. The method of claim 16, wherein the fly ash includes fly ash having a predetermined minimum of calcium.

19. The method of claim 18, wherein the fly ash includes aluminum-based compounds.
